(19) United States
(12) Patent Application Publication
(10) Pub. No.: US 2007/0189042 A1
(43) Pub. Date: Aug. 16, 2007

(54) FLAT PANEL DISPLAY HAVING BACKLIGHT MODULE

(75) Inventors: Wei-Ming Pai, Tainan (TW); Wen-Chin Lan, Tainan (TW); Wen-Tsung Lin, Tainan (TW)

Correspondence Address: FISH & RICHARDSON PC, P.O. BOX 1022, MINNEAPOLIS, MN, 55440-1022, US

(73) Assignee: CHI MEI OPTOELECTRONICS CORPORATION, Tainan (TW)

(21) Appl. No.: 11/672,257

(22) Filed: Feb. 7, 2007

(30) Foreign Application Priority Data
Feb. 8, 2006 (TW) 95104230

(51) Int. Cl. F21V 7/04

(52) U.S. Cl. 362/632

(57) ABSTRACT

A backlight module includes a metal back plate having a front surface, an insulating layer disposed on the front surface of the metal back plate, a metal layout layer disposed on the insulating layer, the metal layout layer including signal lines, and at least one light emitting diode coupled to the signal lines of the metal layout layer.

### CROSS REFERENCE TO RELATED APPLICATIONS

The application claims priority to Taiwan Application No. 95104230, filed Feb. 8, 2006, the contents of which are incorporated by reference.

### BACKGROUND

The description relates to flat panel displays having backlight modules.

FIG. 1 is a diagram of a backlight module 10 that includes light emitting diodes (LEDs) 3 mounted on circuit boards 2. The circuit boards 2 are coupled to a metal back plate 1 having heat dissipating fins 5 for dissipating heat generated by the LEDs 3. An electrically insulating heat dissipating compound 8 (e.g., thermal grease) having a high thermal conductivity is inserted between the LED 3 and the circuit board 2 and between the circuit board 2 and the metal back plate 1 to enhance heat conduction from the LED 3 to the metal back plate 1 through the circuit board 2. Each circuit board 2 includes a metal layout layer 6 disposed on an insulating layer 9, which is disposed on a substrate 7. Each circuit board 2 can be, e.g., a metal core printed circuit board (MCPCB) in which the substrate 7 is made of a metal material, such as silver or copper. Different circuit boards 2 are connected by wires 4, so the LEDs 3 can be, e.g., connected in series.

### SUMMARY

In one aspect, in general, a backlight module includes a metal back plate having a front surface, an insulating layer disposed on the front surface of the metal back plate, a metal layout layer disposed on the insulating layer, the metal layout layer including signal lines, and at least one light emitting diode coupled to the signal lines of the metal layout layer.

Implementations of the display can include one or more of the following features. The insulating layer includes a fiber reinforced epoxy substrate or a composite epoxy substrate. The insulating layer includes a heat dissipating compound that is an electrically insulating material. The backlight module includes at least one heat dissipating fin disposed on a back surface of the metal back plate. The backlight module includes an optical film disposed between the light emitting diode and a liquid crystal layer, the optical film being held in place by a portion of the metal back plate. The optical film includes a prism film, a diffuser, or a brightness enhancement film, or any combination of the above.

In another aspect, in general, a display includes a spatial light modulator, an optical film, and a backlight module. The backlight module includes a metal back plate having a front surface, an electrically insulating layer having a high thermal conductivity disposed on the front surface of the metal back plate, a metal layout layer disposed on the electrically insulating layer, the metal layout layer including signal lines, and at least one light emitting diode coupled to the signal lines of the metal layout layer. The metal back plate is configured to provide a structural support for the optical film, and the optical film is configured to process light from the at least one light emitting diode before the light reaches the spatial light modulator.

Implementations of the display can include one or more of the following features. The optical film includes a prism film, a diffuser, or a brightness enhancement film, or any combination of the above. The spatial light modulator includes liquid crystal cells. The spatial light modulator is held between a front frame and a back frame. The optical film is held between the back frame and the metal back plate.

In another aspect, in general, a display includes a spatial light modulator, a light guide plate having an edge having a lateral surface, the light guide plate having a front surface facing the spatial light modulator, and an edge-lit backlight module. The edge-lit backlight module includes a metal back plate to provide structural support for the light guide plate, an electrically insulating layer disposed on a surface of the metal back plate, the surface of the metal back plate facing the lateral surface of the light guide plate, a metal layout layer disposed on the electrically insulating layer, the metal layout layer including signal lines, and at least one light emitting diode coupled to the signal lines of the metal layout layer. The lateral surface of the light guide plate is configured to receive light from the at least one light emitting diode and direct the light from the front surface of the light guide plate towards the spatial light modulator.

Implementations of the display can include one or more of the following features. The metal back plate has a shape configured to receive and support an edge of the light guide plate, the edge having the lateral surface. The spatial light modulator includes liquid crystal cells. The metal back plate includes heat dissipating fins.

In another aspect, in general, a backlight module includes a light guide plate having a lateral surface, a metal back plate having a front surface, the metal back plate having a shape configured to receive and support a portion of the light guide plate, the front surface of the metal back plate facing the lateral surface of the light guide plate. The backlight module includes an electrically insulating layer disposed on the front surface of the metal back plate, a metal layout layer disposed on the insulating layer, the metal layout layer including signal lines, and at least one light emitting diode coupled to the signal lines of the metal layout layer.

Implementations of the display can include one or more of the following features. The insulating layer includes a fiber reinforced epoxy substrate or a composite epoxy substrate. The electrically insulating layer includes a heat dissipating compound having a high thermal conductivity. The backlight module includes at least one heat dissipating fin disposed on a back surface of the metal back plate. The backlight module includes a reflector disposed on a back surface of the light guide plate, the lateral surface being connected to an edge of the front surface and an edge of the back surface of the light guide plate. The backlight module includes an optical film disposed on the front surface of the light guide plate. The optical film includes a prism film, a diffuser, or a brightness enhancement film, or any combination of the above.

In another aspect, in general, a liquid crystal display includes a backlight module and a liquid crystal panel. The backlight module includes a metal back plate having a front surface, an insulating layer disposed on the front surface of the metal back plate, a metal layout layer disposed on the insulating layer, and at least one light emitting diode coupled to the metal layout layer. The liquid crystal panel is disposed in front of the at least one light emitting diode.

Implementations of the display can include one or more of the following features. The insulating layer includes a fiber reinforced epoxy substrate or a composite epoxy substrate. The insulating layer includes a heat dissipating compound that is an electric insulator. The backlight module includes at least one heat dissipating fin disposed on a back surface of the metal back plate. The liquid crystal display includes an optical film between the light emitting diode and the liquid crystal panel. The optical film includes a prism, a diffuser, or a brightness enhancement film, or any combination of the above.

In another aspect, in general, a liquid crystal display includes a backlight module and a liquid crystal panel. The backlight module includes a light guide plate having a lateral surface and a top surface, a metal back plate having a front surface and a shape configured to receive and support a portion of the light guide plate, the front surface of the metal back plate facing the lateral surface of the light guide plate, an electrically insulating layer disposed on the front surface of the metal back plate, a metal layout layer disposed on the electrically insulating layer, and at least one light emitting diode coupled to the metal layout layer. The liquid crystal panel is positioned in front of the front surface of the metal back plate.

Implementations of the display can include one or more of the following features. The insulating layer includes a fiber reinforced epoxy substrate or a composite epoxy substrate. The electrically insulating layer includes a heat dissipating compound having a high thermal conductivity. The backlight module includes at least one heat dissipating fin disposed on a back surface of the metal back plate. The liquid crystal display includes an optical film disposed between the front surface of the metal back plate and the liquid crystal panel. The optical film includes a prism, a diffuser, or a brightness enhancement film. The backlight module includes a reflector disposed at a bottom surface of the light guide plate.

Advantages of the displays and methods may include one or more of the following. The backlight module includes LEDs that are disposed on the metal layout layer, which is disposed on the metal back plate. The backlight module does not need to use metal core printed circuit boards, so the cost and thickness of the backlight module can be reduced. Usage of heat dissipating compound can be reduced.

### DESCRIPTION OF DRAWINGS

FIG. 1 is a diagram of an LED backlight module.

FIG. 2 is a diagram of a display having an LED backlight module.

FIGS. 3A to 3D are cross-sectional diagrams of portions of backlight modules.

FIG. 4 is a diagram of a display having an LED edge-lit backlight module.

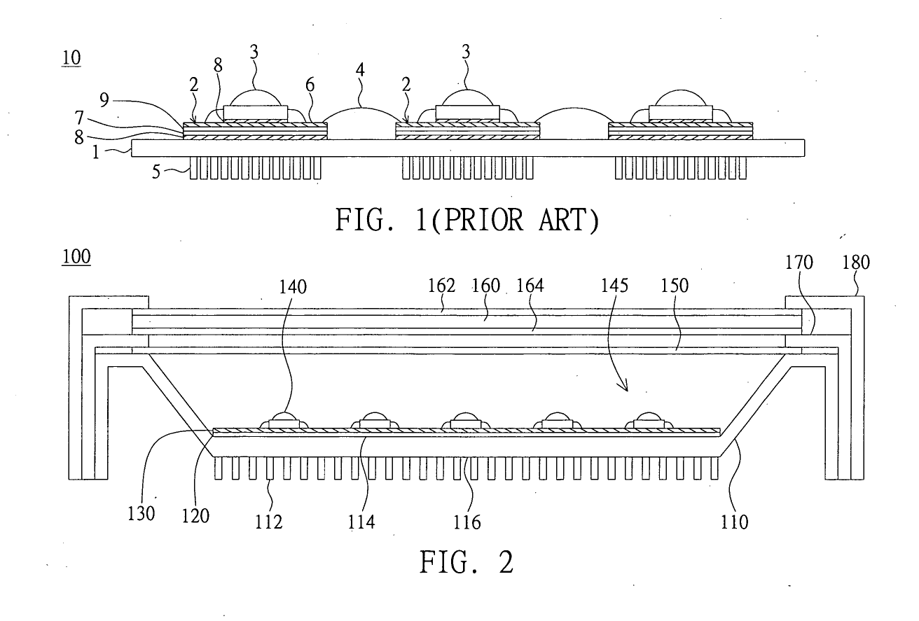

### DETAILED DESCRIPTION

FIG. 2 is a schematic diagram of an example of a liquid crystal display 100 that includes a backlight module 145 having light emitting diodes 140 that are positioned at a back side of a liquid crystal display panel 160. The backlight module 145 includes a metal back plate 110, an electrically insulating layer 120, a metal layout layer 130, and one or more light emitting diodes 140. The insulating layer 120 is positioned on a front surface 114 of the metal back plate 110, and the metal layout layer 130 is positioned on the insulating layer 120. The metal layout layer 130 may include, e.g., signal lines. The light emitting diodes 140 are coupled to signal lines of the metal layout layer 130. The liquid crystal display panel 160 is positioned in front of the backlight module 145. The liquid crystal display panel 160 is positioned between a front frame 180 and a back frame 170. The front frame 180, the back frame 170, and the metal back plate 110 are connected together, e.g., by fasteners or clamps.

Here, the terms “front,” “back,” “rear,” “in front of,” and “behind” describe relative positions of components of the display. The front side of the display 100 refers to the side that is closer to a viewer of the display 100. In FIG. 2, the front side is above a back side of a component. The front frame 180 and the back frame 170 are also referred to as the upper frame 180 and the lower frame 170, respectively. The display can have different orientations.

The insulating layer 120 may include, e.g., a fiber reinforced epoxy substrate, a composite epoxy substrate, an insulating heat dissipating compound having a high thermal conductivity, or any combination of the above. The metal back plate 110 has a back surface 116 opposite to the front surface 114. The metal back plate 110 can be made of, e.g., aluminum, zinc, or another metal having a high thermal conductivity. Heat dissipating fins 112 are provided on the back surface 116 of the metal back plate 110. The heat dissipating fins 112 and the metal back plate 110 can be made of the same material or different materials. The fins 112 and the metal back plate 110 can form an integral unit.

An optical film 150 is held by the metal back plate 110 and the rear frame 170, and positioned in front of the light emitting diodes 140. The optical film 150 can be, e.g., a prism film, a diffuser, a reflective dual brightness enhancement film, or any combination of the above. A front polarizer 162 and a rear polarizer 164 are positioned on a front surface and a back surface, respectively, of the liquid crystal display panel 160. The front polarizer 162 and the rear polarizer 164 are also referred to as the upper polarizer 162 and the lower polarizer 164, respectively. The front frame 180 and the back frame 170 hold together (e.g., by clamping) the liquid crystal display panel 160, the front polarizer 162, and the rear polarizer 164. The front polarizer 162 has a transmission axis that is perpendicular to the transmission axis of the rear polarizer 164.

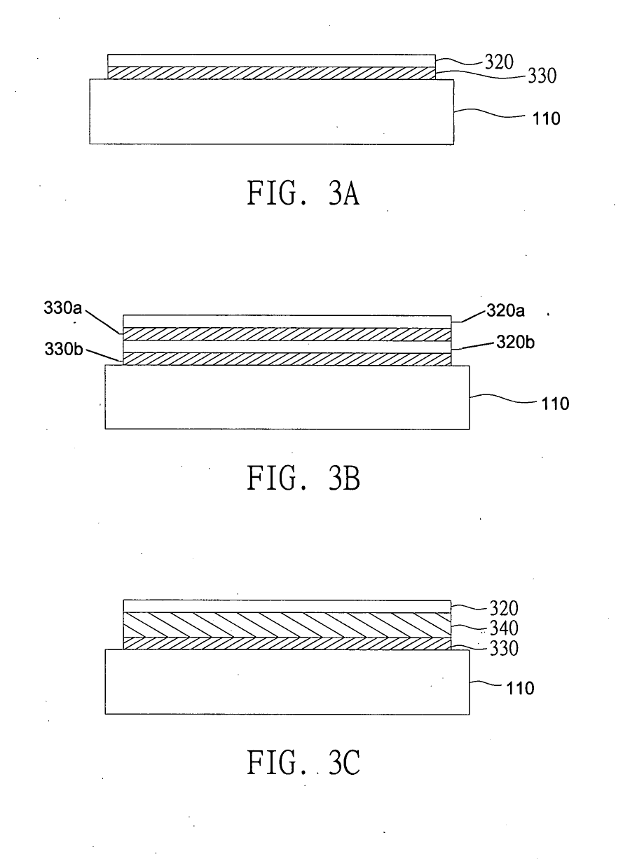

FIGS. 3A to 3D are cross-sectional diagrams of four examples of the metal back plate 110, the insulating layer 120, and the metal layout layer 130. Referring to FIG. 3A, in one example, a copper foil layer 320 is attached to a metal back plate 110 by an adhesive layer 330. The copper foil layer 320 can be processed (e.g., etched) to form layout patterns. The copper foil layer 320 and the adhesive 330 correspond to the metal layout layer 130 and the insulating layer 120, respectively, of FIG. 2.

Referring to FIG. 3B, in one example, two copper foil layers 320a and 320b are bound together using an adhesive layer 330a. The copper foil layer 320b is attached to the metal back plate 110 using an adhesive layer 330b. Connecting vias that pass the adhesive layer 330a connect signal lines on the two copper foil layers 320a and 320b, allowing more complicated layout designs.

Referring to FIG. 3C, in one example, a copper foil layer 320 is positioned on a fiber reinforced epoxy substrate or composite epoxy material substrate 340 (abbreviated as fiber reinforced/composite epoxy substrate 340), which is attached to the metal back plate 110 using an adhesive layer 330. The fiber reinforced/composite epoxy substrate 340 has a high dielectric constant and is a good electric insulator that prevents interference to signals transmitted on the signal lines of the copper foil layer 320.

Referring to FIG. 3D, in one example, two copper foil layers 320a and 320b are positioned on two opposite surfaces of a fiber reinforced/composite epoxy substrate 340. The copper foil layer 320b is attached to the metal back plate 110 through an adhesive layer 330. Using two copper foil layers 320a and 320b allows more complicated layout patterns (e.g., signal line designs) to be implemented. The fiber reinforced/composite epoxy substrate 340 prevents the signals on the signal lines on the two copper foil layers 320 from interfering with each other.

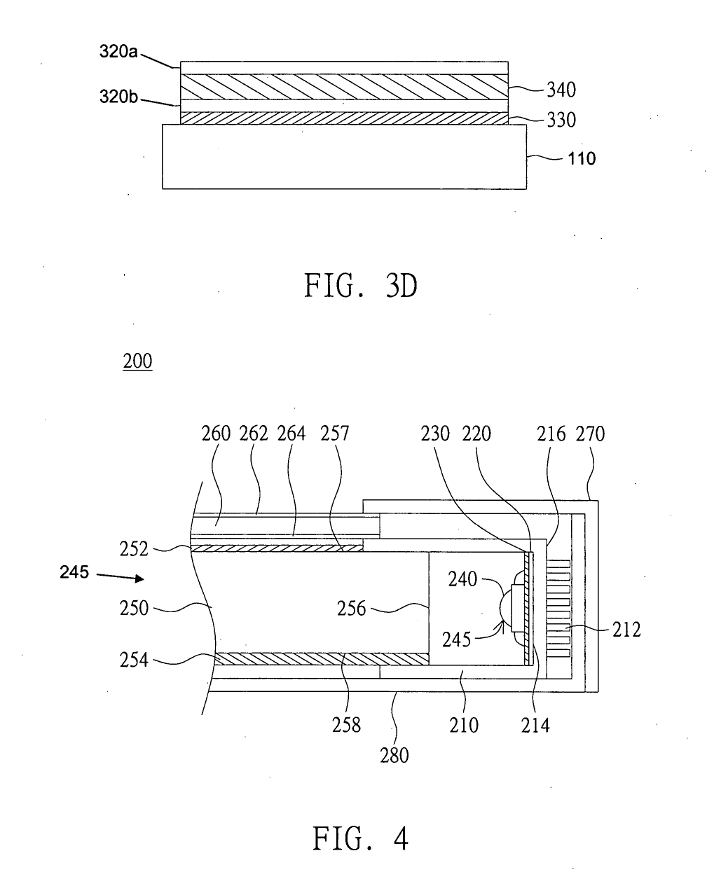

FIG. 4 is a schematic diagram of an example of a liquid crystal display 200 having an edge-lit backlight module 245 positioned at an edge of the display 200. Light from the backlight module 245 is guided by a light guide plate 250 and directed towards a liquid crystal display panel 260. The backlight module 245 includes a metal back plate 210, a light guide plate 250, an electrically insulating layer 220, a metal layout layer 230, and one or more light emitting diodes 240. By placing the light source (in this case, the LEDs 240) of the backlight module 245 near the edge of the display 200, the display 200 can have a smaller thickness, as compared to placing the light source directly behind the liquid crystal display panel 260.

The metal back plate 210 has a front surface 214 and has a shape configured to receive and support a portion of the light guide plate 250. The light guide plate 250 has a lateral surface 256 and a front surface 257. The lateral surface 256 of the light guide plate 250 faces the front surface 214 of the metal back plate 210. The insulating layer 220 is positioned on the front surface 214 of the metal back plate 210. The metal layout layer 230 is positioned on the insulating layer 220. The light emitting diode 240 is coupled to the metal layout layer 230. The liquid crystal display panel 260 is positioned in front of the front surface 257 of the light guide plate 250.

Various modifications can be made to the display 200. For example, the insulating layer 220 can include a fiber reinforced epoxy substrate, a composite epoxy substrate, an electrically insulating heat dissipating compound having a high thermal conductivity, or any combination of the above.

Heat dissipating fins 212 are placed on a back surface 216 of the metal back plate 210. The heat dissipating fins 212 and the metal back plate 210 can be made of the same material or different materials. The fins 212 and the metal back plate 210 can be an integrated piece.

The liquid crystal display 200 includes an optical film 252 positioned between the liquid crystal display panel 260 and the front surface 257 of the light guide plate 250. The optical film 252 can be a prism, a diffuser, a reflective dual brightness enhancement film, or any combination of the above. A reflector 254 is positioned at a back surface 258 of the light guide plate 250. The metal back plate 210 can be made of aluminum, zinc, or any other metal having a good heat dissipating capability.

A front polarizer 262 and a rear polarizer 264 are positioned on the front surface and the rear surface, respectively, of the liquid crystal display panel 260. The front polarizer 262 has a transmission axis that is perpendicular to the transmission axis of the back polarizer 264. The back frame 280 and the front frame 270 hold together (e.g., by clamping) the metal back plate 210, the light guide plate 250, the reflector 254, the optical film 252, the liquid crystal display panel 260, the front polarizer 262 and the rear polarizer 264. The back frame 280 and the front frame 270 may be connected together using, e.g., buckles, fasteners, locks, or screws. The back frame 280 and the front frame 270 can also be secured in place by engaging each other.

For some applications, the insulating layer 220, metal layout layer 230, and the back plate 210 in FIG. 4 can be replaced by the examples shown in FIGS. 3B to 3D. The insulating layer 220 can include a fiber reinforced epoxy substrate, a composite epoxy substrate, an insulating heat dissipating compound, or any combination of the above.

Other implementations and applications are also within the scope of the following claims. For example, the liquid crystal displays 100 (FIG. 2) and 200 (FIG. 4) can have additional films, such as compensation films to enhance viewing angles. The liquid crystal display panel 160 (FIG. 2) or 260 (FIG. 4) can be replaced by other types of spatial light modulators.

What is claimed is:

1. A backlight module comprising:
a metal back plate having a front surface;
an insulating layer disposed on the front surface of the metal back plate;
a metal layout layer disposed on the insulating layer, the metal layout layer comprising signal lines; and
at least one light emitting diode coupled to the signal lines of the metal layout layer.

2. The backlight module of claim 1 wherein the insulating layer comprises at least one of a fiber reinforced epoxy substrate and a composite epoxy substrate.

3. The backlight module of claim 1 wherein the insulating layer comprises a heat dissipating compound that is an electrically insulating material.

4. The backlight module of claim 1, further comprising at least one heat dissipating fin disposed on a back surface of the metal back plate.

5. The backlight module of claim 1, further comprising an optical film disposed between the light emitting diode and a liquid crystal layer, the optical film being held in place by a portion of the metal back plate.

6. The backlight module of claim 5 wherein the optical film comprises at least one of a prism film, a diffuser, and a brightness enhancement film.

7. A display comprising:
a spatial light modulator;
an optical film;
a backlight module comprising
a metal back plate having a front surface;
an electrically insulating layer disposed on the front surface of the metal back plate;
a metal layout layer disposed on the electrically insulating layer, the metal layout layer comprising signal lines; and
at least one light emitting diode coupled to the signal lines of the metal layout layer;
wherein the metal back plate is configured to provide a structural support for the optical film, and the optical film is configured to process light from the at least one light emitting diode before the light reaches the spatial light modulator.

8. The display of claim 7 wherein the optical film comprises at least one of a prism film, a diffuser, and a brightness enhancement film.

9. The display of claim 7 wherein the spatial light modulator comprises liquid crystal cells.

10. The display of claim 7 wherein the spatial light modulator is held between a front frame and a back frame.

11. The display of claim 10 wherein the optical film is held between the back frame and the metal back plate.

12. A display comprising:
a spatial light modulator;
a light guide plate having an edge having a lateral surface, the light guide plate having a front surface facing the spatial light modulator;
an edge-lit backlight module comprising
a metal back plate to provide structural support for the light guide plate;
an electrically insulating layer disposed on a surface of the metal back plate, the surface of the metal back plate facing the lateral surface of the light guide plate;
a metal layout layer disposed on the electrically insulating layer, the metal layout layer comprising signal lines; and
at least one light emitting diode coupled to the signal lines of the metal layout layer;
wherein the lateral surface of the light guide plate is configured to receive light from the at least one light emitting diode and direct the light from the front surface of the light guide plate towards the spatial light modulator.

13. The display of claim 12 wherein the metal back plate has a shape configured to receive and support an edge of the light guide plate, the edge having the lateral surface.

14. The display of claim 12 wherein the spatial light modulator comprises liquid crystal cells.

15. The display of claim 12 wherein the metal back plate comprises heat dissipating fins.

16. A backlight module, comprising:
a light guide plate having a lateral surface;
a metal back plate having a front surface, the metal back plate having a shape configured to receive and support a portion of the light guide plate, the front surface of the metal back plate facing the lateral surface of the light guide plate;
an insulating layer disposed on the front surface of the metal back plate;
a metal layout layer disposed on the insulating layer, the metal layout layer comprising signal lines; and
at least one light emitting diode coupled to the signal lines of the metal layout layer.

17. The backlight module of claim 16 wherein the insulating layer comprises at least one of a fiber reinforced epoxy substrate and a composite epoxy substrate.

18. The backlight module of claim 16 wherein the insulating layer comprises a heat dissipating compound that is an electrically insulating material.

19. The backlight module of claim 16, further comprising at least one heat dissipating fin disposed on a back surface of the metal back plate.

20. The backlight module of claim 16, further comprising a reflector disposed on a back surface of the light guide plate, the lateral surface connected to an edge of the front surface and an edge of the back surface.

21. The backlight module of claim 16, further comprising an optical film disposed on the front surface of the light guide plate.

22. The backlight module of claim 21, wherein the optical film comprises at least one of a prism, a diffuser, and a brightness enhancement film.

23. A liquid crystal display comprising:
a backlight module comprising:
a metal back plate having a front surface,
an insulating layer disposed on the front surface of the metal back plate,
a metal layout layer disposed on the insulating layer, and
at least one light emitting diode coupled to the metal layout layer; and
a liquid crystal panel disposed in front of the at least one light emitting diode.

24. The liquid crystal display of claim 23 wherein the insulating layer comprises at least one of a fiber reinforced epoxy substrate and a composite epoxy substrate.

25. The liquid crystal display of claim 23 wherein the insulating layer comprises a heat dissipating compound that is an electric insulator.

26. The liquid crystal display of claim 23 wherein the backlight module comprises at least one heat dissipating fin disposed on a back surface of the metal back plate.

27. The liquid crystal display of claim 23, further comprising an optical film between the light emitting diode and the liquid crystal panel.

28. The liquid crystal display of claim 27 wherein the optical film comprises at least one of a prism, a diffuser, and a brightness enhancement film.

29. A liquid crystal display, comprising:
a backlight module comprising:
a light guide plate having a lateral surface and a top surface,
a metal back plate having a front surface and a shape configured to receive and support a portion of the light guide plate, the front surface of the metal back plate facing the lateral surface of the light guide plate,
an electrically insulating layer disposed on the front surface of the metal back plate,
a metal layout layer disposed on the electrically insulating layer, and
at least one light emitting diode coupled to the metal layout layer; and
a liquid crystal panel disposed in front of the front surface of the metal back plate.

30. The liquid crystal display of claim 29 wherein the insulating layer comprises at least one of a fiber reinforced epoxy substrate and a composite epoxy substrate.

31. The liquid crystal display of claim 29 wherein the insulating layer comprises a heat dissipating compound that is an electric insulator.

32. The liquid crystal display of claim 29 wherein the backlight module comprises at least one heat dissipating fin disposed on a back surface of the metal back plate.

33. The liquid crystal display of claim 29, further comprising an optical film disposed between the front surface of the metal back plate and the liquid crystal panel.

34. The liquid crystal display of claim 33 wherein the optical film comprises at least one of a prism, a diffuser, and a brightness enhancement film.

35. The liquid crystal display of claim 29 wherein the backlight module comprises a reflector disposed at a bottom surface of the light guide plate.
